(19) United States
(12) Patent Application Publication
(10) Pub. No.: US 2017/0057082 A1
(43) Pub. Date: Mar. 2, 2017

(54) ROBOT SYSTEM ASSEMBLY AND A MOBILE PLATFORM THEREOF

(71) Applicant: Caterpillar Inc., Peoria, IL (US)

(72) Inventors: Dale C. Grigorenko, Corinth, MS (US); Jacob P. Fabrizius, Corinth, MS (US)

(73) Assignee: Caterpillar Inc., Peoria, IL (US)

(21) Appl. No.: 14/840,977

(22) Filed: Aug. 31, 2015

(51) Int. Cl. B25J 9/16

(52) U.S. Cl. CPC B25J 9/16; Y10S 901/01

(57) ABSTRACT

A mobile platform for a robot system is described. The mobile platform includes a base member having a first surface and a second surface. The mobile platform also includes a plurality of walls extending vertically from the first surface to define an enclosure. The enclosure is configured to receive at least a portion of the robot system. Further, the mobile platform includes one or more members extending from the second surface to define an opening. The opening is configured to receive an arm of a lifting device.

### TECHNICAL FIELD

The present disclosure relates to a robot system assembly, and more particularly to a mobile platform for mounting a robot system thereon.

### BACKGROUND

With the development of technology, automatic machines have replaced and reduced the amount of manual work that an individual is needed to perform. For example, robots are developed for various applications to assist the individual and thereby reduce the manual work. From among the various robots, collaborative robots interact and assist humans in their work. Generally, these collaborative robots include one or more arms that are configured to move in one or more directions, commonly referred to as degrees of freedom. Such robots, typically, are used in industries to minimize the amount of time required to complete a task.

Owing to such applicability, the robots may need to be mounted on a platform to hold and provide support to the robot during its operation. More often, the robots may vary in their size. In other words, while some robots are large in size, some robots may be small in size. In such cases, movement of the large sized robots from one location to another may pose a difficulty, while the same may be readily performed in case of small sized robots. For example, in situations where components cannot be moved from one location to another, such small sized robots may be moved near the components, to work on the components. Accordingly, there exists a need for movement of the large sized robots from one location to another.

US patent U.S. Pat. No. 8,868,236 B2 ('236 patent) describes a typical robot for an industrial application. In particular, the '236 patent describes a method and apparatus for calibration of the robot on a platform, in relation to an object, using a measuring unit mounted on the robot. The method described in the '236 patent includes placing computer-aided-design (CAD) models so that the robot reaches the object, manipulating the CAD models to move the measuring unit to a pose in relation to the platform to allow measurement of a feature on the object, storing the pose, and thereafter generating a CAD model of the feature.

### SUMMARY OF THE DISCLOSURE

According to an aspect of the present disclosure, a mobile platform for a robot system is described. In one embodiment, the mobile platform includes a base member having a first surface and a second surface. The mobile platform also includes one or more walls extending vertically from the first surface of the base, to define an enclosure. The enclosure is provided to receive at least a portion of the robot system. Further, the mobile platform includes one or more members extending from the second surface to define an opening. The opening is provided to receive an arm of a lifting device, such as a fork lift.

According to another aspect of the present disclosure, a robot system assembly is also described. The robot system assembly includes the mobile platform. Further, the mobile platform includes an enclosure, where the enclosure includes the base member having the first surface and the second surface, and the one or more walls extending vertically from the first surface. The mobile platform further includes one or more members extending from the second surface to define the opening. In addition, the mobile platform includes a mounting fixture disposed in the enclosure. The mounting fixture may be provided to removably secure a robot system thereon.

According to yet another aspect to the present disclosure, the mobile platform for the robot system may include the base member having the first surface and the second surface, and one or more walls extending vertically from the first surface to define an enclosure. The enclosure may be configured to receive at least a portion of the robot system. Further, the mobile platform includes one or more members extending from the second surface to define the opening, the opening configured to receive the arm of the lifting device. The mobile platform also includes the mounting fixture disposed in proximity to a first end of the mobile platform. The mounting fixture is provided to removably secure the robot system thereto. In addition, the mobile platform includes a worktable pivotally connected to a second end of the mobile platform. The worktable may be rotated between an operating state and a folded state.

Other features and aspects of this disclosure will be apparent from the following description and the accompanying drawings.

### BRIEF DESCRIPTION OF THE DRAWINGS

FIG. 1 illustrates a perspective view of a mobile platform according to one embodiment of the present disclosure;

FIG. 2 illustrates the perspective view of the mobile platform with a worktable in a folded state, according to one embodiment of the present disclosure;

FIG. 3 illustrates a perspective view of a rear portion of the mobile platform with a mounting fixture, according to one embodiment of the present disclosure;

FIG. 4 illustrates a top view of the mounting fixture, according to one embodiment of the present disclosure;

FIG. 5 illustrates a planar side view of the mobile platform, according to one embodiment of the present disclosure;

FIG. 6 illustrates another planar side view of the mobile platform having a power inlet, according to one embodiment of the present disclosure;

FIG. 7 illustrates a robot system assembly, according to one embodiment of the present disclosure;

FIG. 8 illustrates the robot system assembly being lifted by an arm of a lifting device, according to one embodiment of the present disclosure; and

FIG. 9 illustrates the robot system assembly in operation, according to one embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims

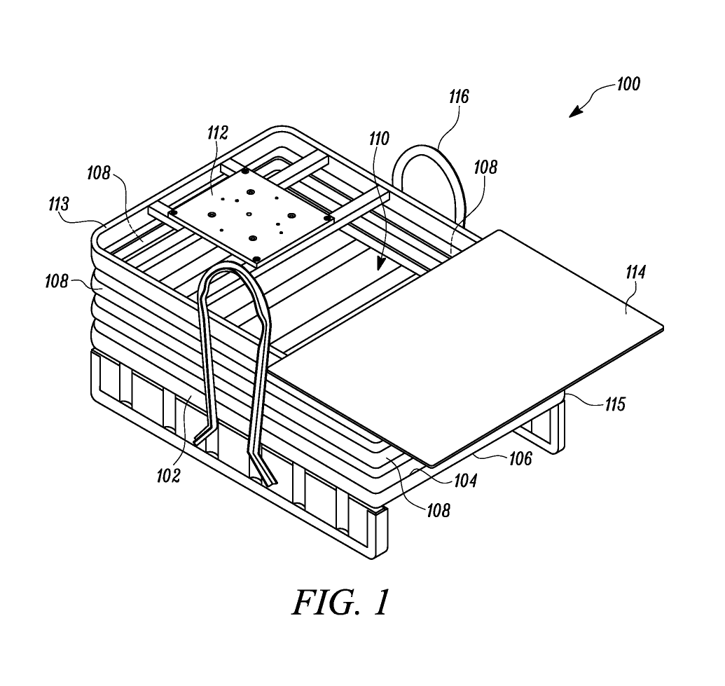

FIG. 1 illustrates a perspective view of a mobile platform 100 according to one embodiment of the present disclosure. The mobile platform 100 may include a base member 102 having a first surface 104 and a second surface 106. In one example, the base member 102 may be a rectangular plate having a predetermined width. In other words, the distance between the first surface 104 and the second surface 106 may be understood as the predetermined width of the base member 102. The predetermined width of the base member 102 may provide rigidity to the mobile platform 100.

The mobile platform 100 may include one or more walls 108. The one or more walls 108 extend vertically from the first surface 104 of the base member 102. In other words, the one or more walls 108 may extend in a direction perpendicular to the first surface 104 of the base member 102. Although the FIG. 1 illustrates the walls 108 being perpendicular to the base member 102, it will be appreciated that such configuration of the walls 108 and the base member 102 should not be construed as limitation. In one example, the walls 108 may also extend in a direction inclined to the first surface 104 of the base member 102.

With such construction, the walls 108 and the base member 102 define an enclosure 110. In other words, the walls 108 extending from the first surface 104 of the base member 102 form a hollow space in the mobile platform 100, as illustrated in the FIG. 1. In one example, the base member 102 and the walls 108, together forming the enclosure 110, may be formed as a single component. Alternatively, in another example, the base member 102 and the walls 108 may be formed as individual components and the walls 108 may be attached to the first surface 104 of the base member 102 through a known joining technique, such as welding, riveting, and fastening. The walls 108 may include one or more grooves to increase the strength of the walls 108. Based on the shape and cross-section of the base member 102, the shape of the enclosure 110 may accordingly be obtained. In one example, the enclosure 110 may be generally cube shaped.

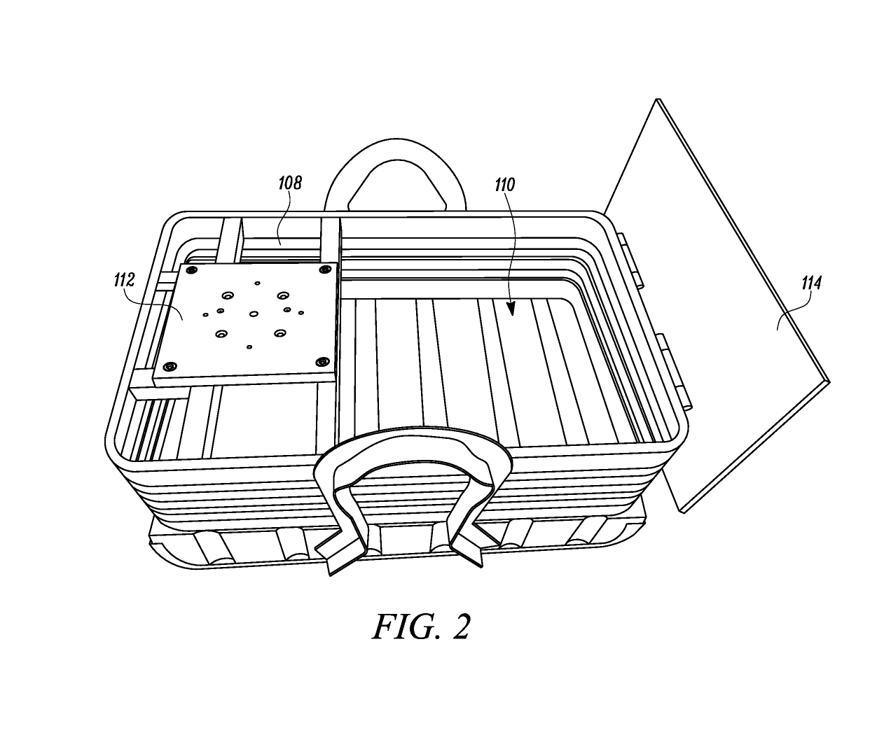

In addition, the mobile platform 100 may include a mounting fixture 112 disposed in proximity to a first end 113 of the mobile platform 100 and a worktable 114 disposed in proximity to a second end 115 of the mobile platform 100. The first end 113 and the second end 115 of the mobile platform 100 may be understood as the ends of the mobile platform 100 along a longitudinal axis of the mobile platform 100. However, it will be appreciated that the illustration of FIG. 1 does not limit the manner in which the mounting fixture 112 and the worktable 114 are provided in the mobile platform 100. In one example, subject to the construction of the mobile platform 100, such as the size and the shape, the mounting fixture 112 and the worktable 114 may be disposed at the respective ends along a transverse axis of the mobile platform 100. Further, FIG. 1 illustrates the worktable 114 in an operating state. The manner in which the worktable 114 is coupled to the second end 115 of the mobile platform 100 would be described with reference to FIG. 2. Furthermore, the mobile platform 100 may also include a handle 116 attached to the walls 108. The handle 116 may facilitate the lifting of the mobile platform 100.

FIG. 2 illustrates the perspective view of the mobile platform 100 with the worktable 114 in a folded state. In one embodiment, the worktable 114 may be pivotally connected to the second end 115 of the mobile platform 100. As such, the worktable 114 may be rotated between the operating state and the folded state. For the purpose of providing such rotatable movement, in one example, the worktable 114 may be coupled to the second end 115 through, one or more hinge pivots, spring pivots, or any other mechanical linkages which allows for the rotatable movement of the worktable 114.

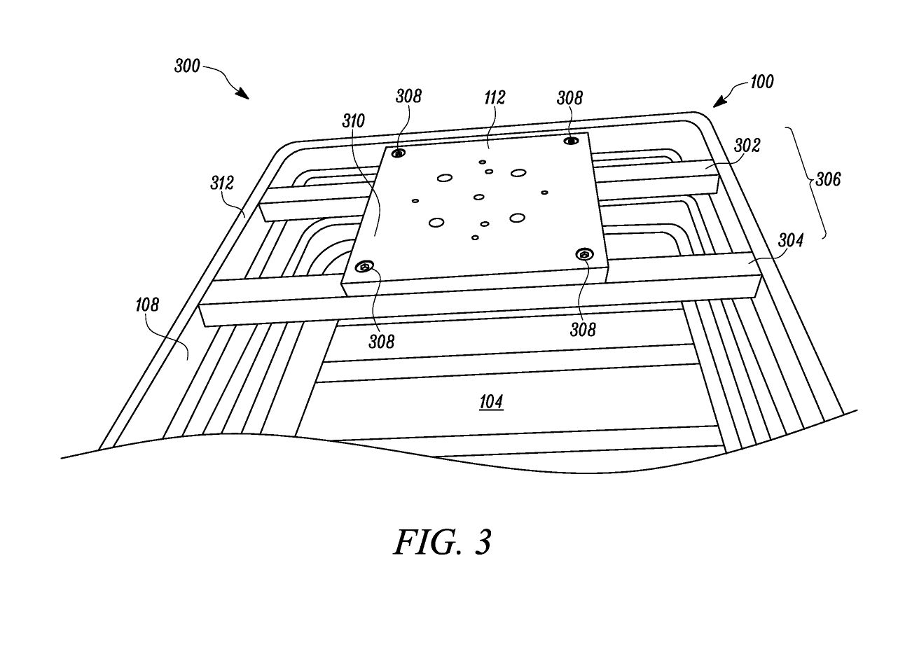

Further, a rear portion 300 of the mobile platform 100 is illustrated in FIG. 3. In particular, the FIG. 3 illustrates a perspective view of the rear portion 300 of the mobile platform 100. As mentioned earlier, the mobile platform 100 has the first end 113 and the second end 115, where the first end 113 is included in the rear portion 300 of the mobile platform 100. In one embodiment, the mounting fixture 112 may be disposed in the rear portion 300, that is, at the first end 113, of the mobile platform 100. In an exemplary embodiment, the rear portion 300 of the mobile platform 100 may include one or more transverse members, such as a first transverse member 302 and a second transverse member 304, hereinafter collectively and commonly referred to a transverse member(s) 306. The transverse members 306, in one example, may be a rod having, but not limited to, a square or rectangular cross-section profile. The transverse members 306 may extend along the width of the mobile platform 100 and both ends of the transverse members 306 may be attached to an inner surface of the walls 108, respectively.

In one embodiment, the mounting fixture 112 may be mounted on the transverse members 306 through one or more fasteners 308, as illustrated in FIG. 3. In said embodiment, the mounting fixture 112 may be disposed proximal to the first end 113 of the mobile platform 100. Owing to the transverse members 306, the mounting fixture 112 may be disposed at a predetermined distance from the first surface 104 of the base member 102.

In one example, a top surface 310 of the mounting fixture 112 that is facing away from the first surface 104 may be aligned with a peripheral surface 312 of the walls 108. In other words, the mounting fixture 112 may be disposed at a height substantially equal to the height of the walls 108 of the mobile platform 100. In another example, the mounting fixture 112 may be disposed at a height greater or lesser than the height of the walls 108. Further, position of the mounting fixture 112 along the transverse axis, that is, along the width of the mobile platform 100, may be predetermined. Alternatively, the mounting fixture 112 and the transverse members 306 may be provided with certain railing arrangement, so that the railing of the mounting fixture 112 cooperates with that of the transverse members 306 to move the mounting fixture 112 along the transverse axis. In such a case, the mounting fixture 112 may be locked at a desired position along the length of the transverse members 306.

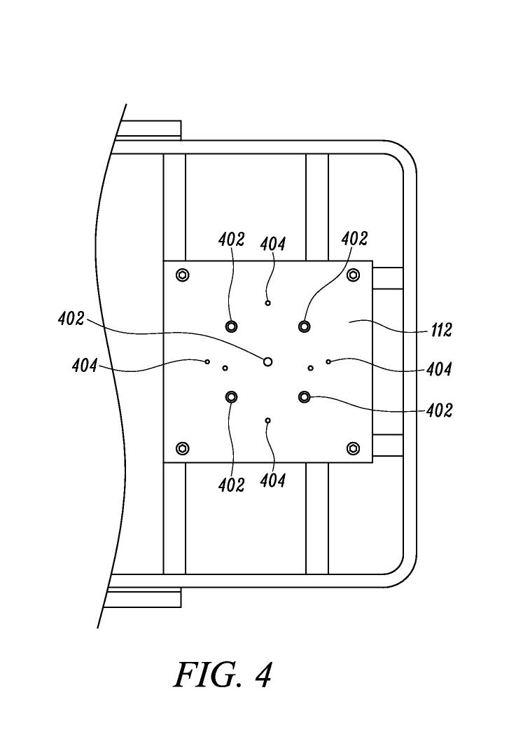

FIG. 4 illustrates a top view of the mounting fixture 112. In particular, FIG. 4 illustrates the top surface 310 of the mounting fixture 112. The mounting fixture 112 may include one or more first set of fastening apertures 402. Each of the first set of fastening apertures 402 may be understood as the apertures provided in the mounting fixture 112, where the apertures includes screw threads for fastening a machine, such as a robot system, thereon. Accordingly, the robot system may be removably secured on the mounting fixture 112. Further, the mounting fixture 112 may also include a second set of fastening apertures 404. In one example, each of the second set of fastening apertures 404 may have a smaller diameter compared to the diameter of a corresponding first set of fastening apertures 402. Furthermore, the second set of fastening apertures 404 may be formed around the first set of fastening apertures 402 in a predefined manner. Alternatively, the first set of fastening apertures 402 and the second set of fastening apertures 404 may be formed in a matrix manner on the mounting fixture 112. Such configuration of the first set of fastening apertures 402 and the second set of fastening apertures 404 may hold the robot system rigidly when the robot system is fastened to the mounting fixture 112.

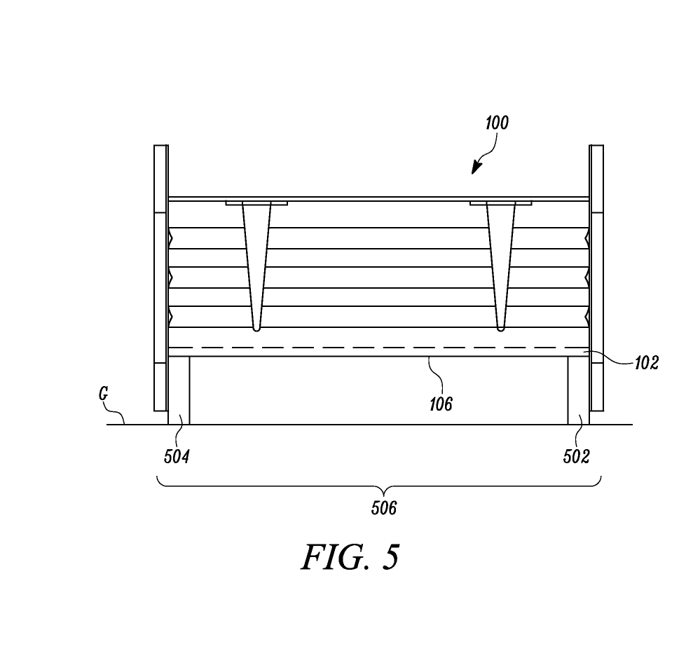

FIG. 5 illustrates a planar side view of the mobile platform 100. The mobile platform 100 may also include one or more members 502 and 504, hereinafter commonly and alternatively referred to as the one or more members 506. The one or more members 506 extend in a direction downward and perpendicular to the second surface 106 of the base member 102. In other words, the one or more members 506 extend in a direction opposite to that the walls 108. The one or more members 506 may be understood as legs for the mobile platform 100, where the one or more members 506 allow the second surface 106 to be disposed at a certain height from the ground G when the mobile platform 100 is rested on the ground G.

For the purpose of convenience in description, the one or more members 506 may be individually considered as a first member 502 and a second member 504. In one case, the first member 502 and the second member 504 may be formed as individual components and thereafter be attached to the second surface 106 of the base member 102 through known methods. For example, the first member 502 and the second member 504 may be attached by one of welding, fastening, riveting, or a combination thereof. The first member 502 may be attached at one end of the second surface 106 and the second member 504 may be attached to the other end of the second surface 106. With such configuration, the first member 502 and the second member 504 define an opening at a bottom portion of the mobile platform 100. This opening may be configured to receive an arm of a lifting device, such a fork of a fork lift.

In cases where the base member 102 has a rectangular cross-section, the first member 502 and the second member 504 may either be attached at the respective ends of the second surface 106 along the length sides or width sides of the rectangular cross-section. However, in cases where the cross-section of the base member 102 is a circle or an ellipse, the first member 502 and the second member 504 may be formed with corresponding arcuate surfaces. Accordingly, the first member 502 and the second member 504 may be attached to the second surface 106 in a diagonally opposite manner, such that the opening is defined between the first member 502 and the second member 504, to receive the arm of the lifting device therein. Further, in one example, one or more flanges may be attached to the first member 502 and the second member 504, to guide and thereby receive the arms of the lifting device. In this case, the one or more flanges may be understood as ribs protruding from the surface of the first member 502 and the second member 504, so that a space for receiving the arms of the lifting device is formed between the ribs and the second surface 106, respectively.

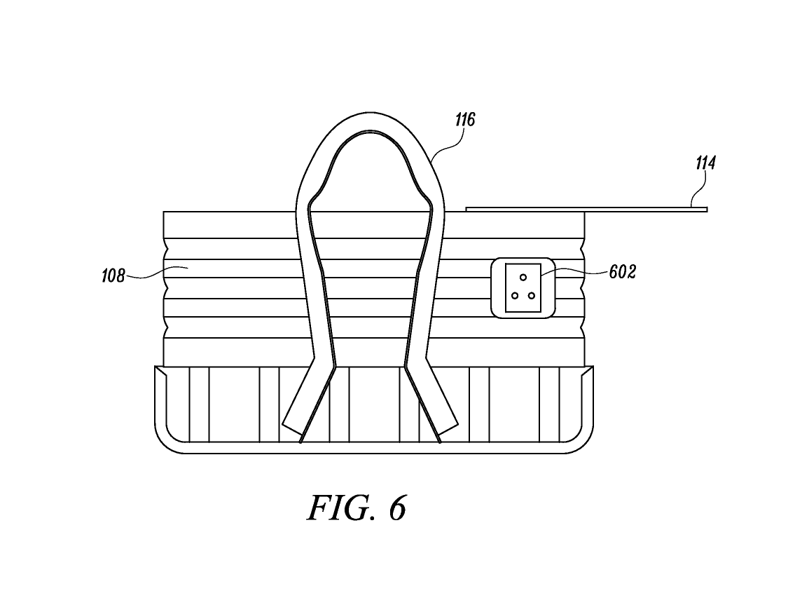

FIG. 6 illustrates another planar side view of the mobile platform 100 having a power inlet 602. According to an aspect of the present disclosure, the mobile platform 100 may include the power inlet 602, where the power inlet 602 is configured to receive a power supply and thereafter power the robot system that is mounted on the mounting fixture 112. The power inlet 602 may be understood as an electrical point, such as an electrical socket, provided on the mobile platform 100 to operate the robot system. In one example, the power inlet 602 may be provided on one of the one or more walls 108. Further, the power inlet 602 may include a socket with multiple configurations of electrical pins, so that any type of plug-socket connection may be supported to operate the robot system.

Furthermore, in one aspect of the present disclosure, the mobile platform 100 may include a battery to power the robot system. In such case, the power inlet 602 may be electrically coupled to the battery, for charging the battery, where the battery powers the robot system. Alternatively, a generator may be provided to power the robot system, where the generator may be aided by a fuel supply system. Accordingly, the battery and the generator may be disposed in the enclosure 110 of the mobile platform 100. The enclosure 110 may also be adapted to accommodate any other combination of systems, such as a combination of electrical-electronic circuits, which may be implemented to operate the robot system.

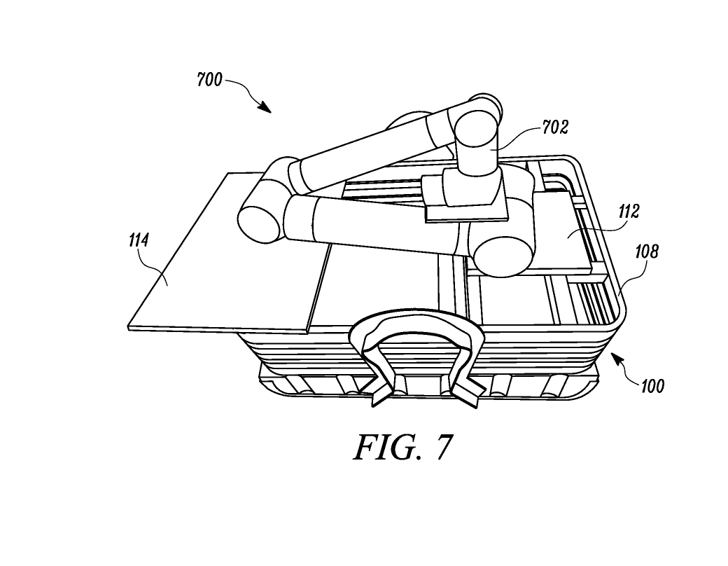

FIG. 7 illustrates a robot system assembly 700. According to one aspect of the present disclosure, the robot system assembly 700 may include a robot system 702 removably mounted on the mounting fixture 112 of the mobile platform 100. In one example, the robot system 702 may be a collaborative robot. A robot system 702 configured to interact and assist an operator in a confined workspace may be understood as the collaborative robot. In one example, the robot system 702 may be configured to complete a task on a component positioned on the worktable 114.

Various embodiments disclosed herein are to be taken in the illustrative and explanatory sense, and should in no way be construed as limiting of the present disclosure.

### INDUSTRIAL APPLICABILITY

As mentioned earlier, generally, robot systems 702 are required to be moved from one location to another on a floor of a factory. As such, the robot systems 702 may be sensitive to certain configuration settings and spatial orientations. In such a condition, attempts to manually move the robot systems 702 may disturb the settings of the robot systems 702 and may present difficulties or inaccuracies in operation of the robot system 702. In addition, conventional lifting devices also do not address this limitation of the robot systems 702. Therefore, the conventionally known modes for moving the robot system 702 from one location to another in the floor of the factory are not ideal.

To this end, the present disclosure describes a mobile platform 100 for the robot system 702. As described earlier, the mobile platform 100 includes the worktable 114 which may be rotated between the operating state and the folded state. In the operating state, the worktable 114 may be positioned parallel to the ground G and various components may be positioned on the worktable 114 for the robot system 702 to operate on. Further, in the folded state, the worktable 114 may be positioned perpendicular to the ground G. In cases where the robot system 702 needs to carry out a welding operation in front of the mobile platform 100, the folded state of the worktable 114 may function as a shield to the mobile platform 100 and to various components positioned inside the enclosure 110.

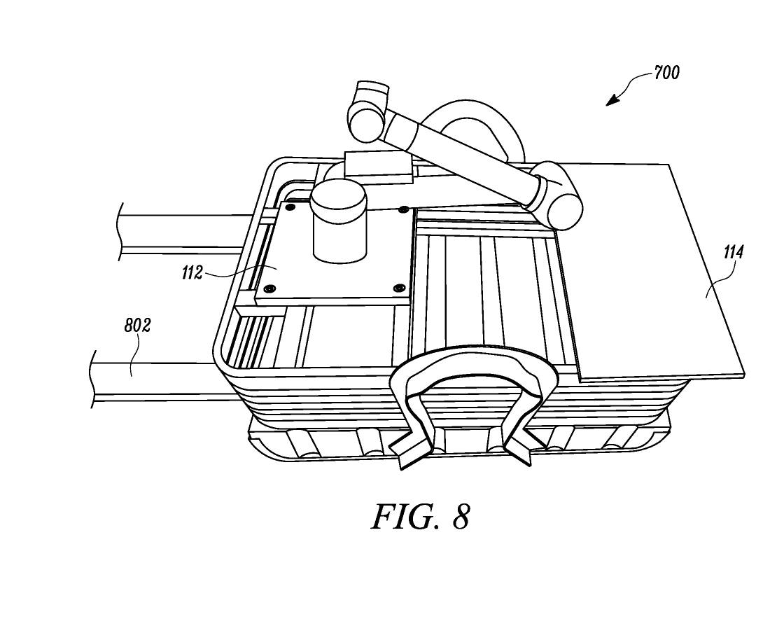

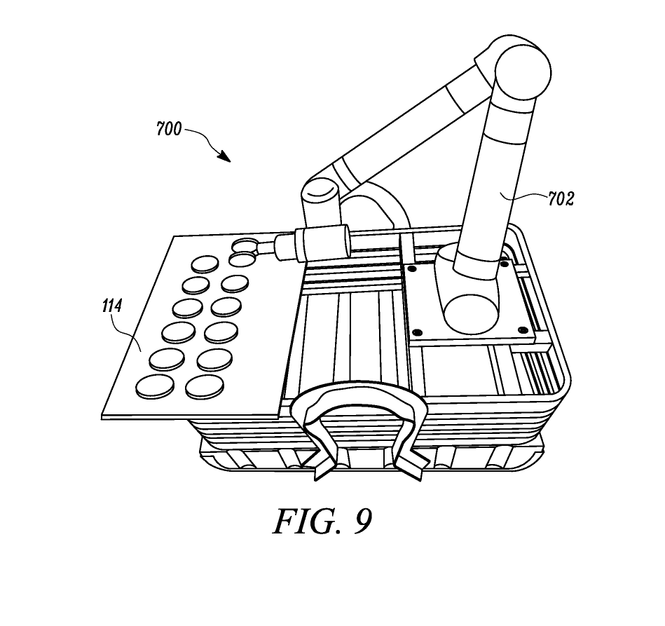

Furthermore, embodiments of the present disclosure have applicability for use and implementation in industries which involve automation of various jobs at one or more locations within the factory. For the purpose of description of the applicability, reference will be made to FIG. 8 and FIG. 9 of the present disclosure.

FIG. 8 illustrates the robot system assembly 700 at a first location and in communication with the arm 802 of a lifting device (not illustrated). In an embodiment, the arm 802 may be a fork of the forklift. As described earlier, the mobile platform 100 includes the one or more members 506 which extend in the direction perpendicular and downwards from the second surface 106 of the base member 102. Further, the one or more members 506 define the opening therebetween, where the opening is configured to receive the arm 802 of the forklift. With such arrangement, the forklift may be moved proximal to the robot system assembly 700, such that the arm 802 of the forklift may be introduced into the opening with ease. Subsequently, with the aid of the forklift, the robot system assembly 700 may be lifted with reduced effort and moved to a second location to perform various functions.

FIG. 9 illustrates the robot system assembly 700 in operation at the second location. Once the robot system assembly 700 is positioned at the second location, the robot system 702 may be connected to a power source, via the power inlet 602. Owing to such construction of the robot system assembly 700 and/or the mobile platform 100, the robot system 702 may be mounted on the mounting fixture 112 and may be easily moved from one place to another. The robot system assembly 700 may assist the members of the factory to perform routine work once moved to the desired location.

Generally, as mentioned earlier, such robot systems 702 are configured to operate based on certain geometrical and spatial orientations. With the configuration of the mobile platform 100 of the present disclosure, the robot system 702 and/or the robot system assembly 700 may be lifted without disturbing the orientations of the robot system 702. In addition, owing to the presence of the one or more members 506, the mobile platform 100 may be positioned accurately at a desired location for operation of the robot system 702. The one or more members 506 assist the mobile platform 100 to maintain the desired position and orientation of the robot system 702 without further movement during the lowering of the forks of the forklift. Therefore, the mobile platform 100 of the present disclosure facilitates efficient handling and movement the robot system 702 from one location to another within the floor of the factory.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A mobile platform for a robot system, the mobile platform comprising:
a base member comprising a first surface and a second surface;
a plurality of walls extending vertically from the first surface to define an enclosure, the enclosure configured to receive at least a portion of the robot system; and
one or more members extending from the second surface to define an opening, the opening configured to receive an arm of a lifting device.

2. The mobile platform of claim 1 further comprising a mounting fixture configured to removably secure the robot system thereon.

3. The mobile platform of claim 2, wherein the mounting fixture is disposed in proximity to a first end of the mobile platform.

4. The mobile platform of claim 1 further comprising a worktable disposed in proximity to a second end of the mobile platform.

5. The mobile platform of claim 4, wherein the worktable is pivotally connected to the second end of the mobile platform, and wherein the worktable is rotatable between an operating state and a folded state.

6. The mobile platform of claim 1 further comprising a power inlet disposed in one of the plurality of walls of the mobile platform, the power inlet configured to receive a power supply to power the robot system.

7. The mobile platform of claim 1, wherein the opening is configured to receive a fork of a fork lift.

8. The mobile platform of claim 1, wherein the enclosure is substantially rectangular.

9. A robot system assembly comprising:
a mobile platform comprising:
a base member comprising a first surface and a second surface;
a plurality of walls extending vertically from the first surface to define an enclosure;
one or more members extending from the second surface of the base member to define an opening, the opening configured to receive an arm of a lifting device therein; and
a mounting fixture disposed in the enclosure; and
a robot system removably secured on the mounting fixture of the mobile platform.

10. The robot system assembly of claim 9, wherein the mounting fixture is disposed in proximity to a first end of the mobile platform.

11. The robot system assembly of claim 9, wherein the robot system is removably secured on the mounting fixture by one or more fastening members.

12. The robot system assembly of claim 9, wherein the mobile platform comprises a worktable disposed in proximity to a second end of the mobile platform.

13. The robot system assembly of claim 12, wherein the worktable is pivotally connected to the second end of the mobile platform, and wherein the worktable is rotatable between an operating state and a folded state.

14. The robot system assembly of claim 12, wherein the robot system is configured to complete a task on a component positioned on the worktable.

15. The robot system assembly of claim 9 further comprising a power inlet disposed in one of the plurality of walls of the mobile platform, the power inlet configured to receive a power supply to power the robot system.

16. The robot system assembly of claim 9, wherein the enclosure is substantially rectangular.

17. The robot system assembly of claim 9, wherein the opening is configured to receive a fork of a fork lift.

18. The robot system assembly of claim 9, wherein the robot system is a collaborative robot.

19. A mobile platform for a robot system, the mobile platform comprising:
a base member comprising a first surface and a second surface;
a plurality of walls extending vertically from the first surface to define an enclosure, the enclosure configured to receive at least a portion of the robot system;
one or more members extending from the second surface to define an opening, the opening configured to receive an arm of a lifting device;
a mounting fixture disposed in proximity to a first end of the mobile platform, the mounting fixture having the robot system removably secured thereto; and
a worktable pivotally connected to a second end of the mobile platform, the worktable rotatable between an operating state and a folded state.

20. The mobile platform of claim 19 further comprising a power inlet disposed in one of the plurality of walls of the enclosure, the power inlet configured to receive a power supply to power the robot system.
